(19) United States
(12) Patent Application Publication
(10) Pub. No.: US 2025/0106476 A1
(43) Pub. Date: Mar. 27, 2025

(54) METHODS AND SYSTEMS FOR USING MACHINE-LEARNING EXTRACTS AND SEMANTIC GRAPHS TO CREATE STRUCTURED DATA TO DRIVE SEARCH, RECOMMENDATION, AND DISCOVERY

(71) Applicant: Adeia Guides Inc., San Jose, CA (US)

(72) Inventors: Lijin Chungapalli, Bengaluru (IN); Venkata Babji Perambattu, Bengaluru (IN)

(21) Appl. No.: 18/910,482

(22) Filed: Oct. 9, 2024

Related U.S. Application Data
(63) Continuation of application No. 16/289,573, filed on Feb. 28, 2019, now abandoned.

(30) Foreign Application Priority Data
Sep. 4, 2018 (IN) 201841033185

(51) Int. Cl. H04N 21/466; G06F 16/36; G06F 16/901; G06F 18/243; G06F 40/263; G06F 40/279; G06N 5/01; G06N 5/02; G06N 5/022; G06N 5/04; G06N 20/00; G06V 10/776; H04N 21/482

(52) U.S. Cl. CPC H04N 21/4668; G06F 16/36; G06F 16/9024; G06F 16/9027; G06F 18/24323; G06N 5/02; G06N 5/04; G06N 20/00; G06V 10/776; H04N 21/4826; G06F 16/367; G06F 40/263; G06F 40/279; G06N 5/01; G06N 5/022

(57) ABSTRACT

Methods and systems for using a combination of semantic graphs and machine learning to automatically generate structured data, recognize important entities/keywords, and create weighted connections for more relevant search results and recommendations. For example, by inferring relevant entities, metadata results are richer and more meaningful, enabling faster decision-making for the consumer and stronger viewership for the content owner.

### CROSS-REFERENCE TO RELATED APPLICATIONS

This application is a continuation of U.S. patent application Ser. No. 16/289,573 filed Feb. 28, 2019, which claims priority to India patent application No. 201841033185 filed Sep. 4, 2018, the disclosures of which are hereby incorporated by reference herein in their entireties.

### BACKGROUND

Today's consumers have the advantage of choice—but from an ocean of content, including movies, programs, news, and short-form video from an array of linear and streaming services. With so much content available for consumption, consumers may find it difficult to filter through this content in order to find something they wish to view. In fact, the plethora of content available has given rise to a phenomenon called “show-dumping,” whereby consumers simply give up on programs due to the challenges involved in accessing them. Show-dumping creates a large problem for both content owners and content consumers. Content owners may heavily invest in producing content yet struggle to ensure consumers can access it. Likewise, content consumers cannot find desirable content despite the content being readily available, but difficult to find.

### SUMMARY

In view of this problem, methods and systems are described herein for an application that allows users to more quickly and more easily find content they wish to consume. In order to provide this solution, a deeper understanding of content is required. For example, because there is so much content, largely lacking structured metadata, traditional search and recommendation techniques increasingly fail users as the amount of content increases. Once this problem is understood, the solution described herein can be used to overcome this problem.

For example, conventional search and recommendation systems rely on entity extraction based on statistic-driven models. For example, in such systems, an identified term (e.g., a descriptive term found in metadata for a media asset) is assigned other related terms based on a statistic indicating how likely the related term corresponds to the identified term. Thus, when an input (e.g., a user search request) is received, the system compares the terms in the input to the related terms. If one or more of the related terms corresponds to a term in the input, the system determines a match.

However, as the amount of content grows, and thus the amount of identified terms, related terms, etc., for that content grows exponentially, these conventional statistics-driven models for entity extraction fail to provide accurate search results that are tailored to the wishes of the individual user. For example, despite the presence of ever-more-powerful processors, which can process the ever-increasing amounts of data, these systems will still fail to solve the aforementioned problems, as they fail to interpret inputs outside the conventional statistics-driven model. In particular, these systems fail to gain a semantic understanding of a given input and use this information to further the search, recommendation, and discovery process.

At a threshold level, the addition of more information (e.g., regarding semantic relationships) to a system overburdened by excess data, as discussed above, appears to only further exacerbate the existing problems. However, recent advancements in machine-learning offer a way to use this increased data efficiently in order to provide desired results. Specifically, through the use of a specific architecture featuring four distinct stages, namely, pronoun resolution, candidate identification, semantic graph creation, and node scoring, the systems and methods described herein provide for an application that provides an enhanced F1 score, which is the harmonic mean between precision and recall and is used as a statistical measure to rate performance, when providing search, recommendation, and discovery features. That is, the systems and methods herein leverage the importance of the nodes in a semantic graph to train a machine-learning model that will automatically determine the relevance of an entity in a given text string in order to provide better results for users. As a practical matter, combining machine-learning methods and semantic graphs in this unique way adds much-needed context and can alleviate consumer frustration, as well as strengthen viewership for content owners.

In some aspects, methods and systems described herein provide search, recommendation, and discovery features. For example, the system may gather a data set. The user may input text strings from an external data set or the system may actively gather data from the web to populate the data set. The system may then perform pronoun resolution across the data set. For example, the system may identify and label each pronoun within text strings in the data set. The system may then perform candidate identification across the data set. For example, the system may apply POS (Part-Of-Speech) tagging on the data set to identify all noun chunks within text strings in the data set. The system may then create a semantic graph that identifies a plurality of key entities and a plurality of associations between the plurality of key entities. The semantic graph may comprise nodes which correspond to candidates from the data set connected by directed edges representing semantic relations between the nodes. The system may then receive, by a user input interface, a user input. The user input may be a text string or an utterance. The system may then process the user input using the semantic graph. For example, the system may match candidates from the user input with nodes in the semantic graph. By traversing the dependency tree, the system may learn the meaning of the input. The system may additionally learn relevant information related to the input. The system may then generate an output based on the processed user input. For example, the output may comprise an answer to the user input, a recommendation based on the user input, relevant information to the user input, or other information.

In some aspects, methods and systems provide content recommendation by automatically determining relevancies of entities in text strings. For example, the system may receive, by a user input interface, a text string such as “What was the movie with the iceberg? It sinks the ship.” The system may then identify, by control circuitry, a pronoun in the text string. For example, the system may identify “it” as a pronoun. The system may then resolve, by the control circuitry, the pronoun into a proper noun to create a resolved text string. For example, the system may determine that the pronoun “it” refers to the noun “iceberg” to create the resolved text string: “What was the movie with the iceberg? The iceberg sinks the ship.” The system may then identify, by the control circuitry, a noun chunk in the resolved text string. For example, the system may identify the noun “iceberg” as a first noun chunk and the noun “ship” as a second noun chunk. The system may then process, by the control circuitry, the noun chunk using a classifier based on a semantic graph featuring a plurality of noun chunks, wherein each of the plurality of noun chunks is scored based on a closeness centrality metric and a betweenness centrality metric, wherein the closeness centrality metric is a measure of a sum of a length of a shortest path between a respective node and each of the other nodes in the semantic graph, and wherein the betweenness centrality metric is a measure of centrality in the semantic graph of a respective node. For example, the semantic graph may feature a plurality of nouns as nodes, wherein the nouns correspond to nouns of a dataset from a particular source and/or of a particular subject matter. The system may then determine, by the control circuitry, an entity, based on processing the noun chunk using the classifier. For example, the system may determine an entity (e.g., a noun, an entity, a title of media content, a computer-generated query, etc.) by determining a score for each node of the semantic graph. The system may then determine the node having the highest score and retrieve the entity corresponding to that node. The system may then generate for display, on a display device, the entity, in response to the received text string. For example, the system may include the entity in a computer-generated response to a user. The computer-generated response may include a list of search results featuring media content corresponding to the entity.

It should be noted that the methods and systems described herein for one embodiment may be combined with other embodiments as discussed herein.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a user interface, in accordance with some embodiments of the disclosure;

FIG. 2 shows another illustrative example of a user interface, in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 shows a table featuring results for an exemplary model, in accordance with some embodiments of the disclosure;

FIG. 6 is an illustrative example of the architecture used to provide the search, recommendation, and discovery features, in accordance with some embodiments of the disclosure;

FIG. 7 shows an exemplary semantic graph, in accordance with some embodiments of the disclosure; and

FIGS. 8-10 show illustrative examples of extracted entities and roles, in accordance with some embodiments of the disclosure;

FIG. 11 shows an illustrative example of a user interface, in accordance with some embodiments of the disclosure;

FIG. 12 shows another illustrative example of a user interface, in accordance with some embodiments of the disclosure; and

FIG. 13 shows still another illustrative example of a user interface, in accordance with some embodiments of the disclosure;

FIG. 14 depicts an illustrative flowchart of a process used to provide the search, recommendation, and discovery features, in accordance with some embodiments of the disclosure;

FIG. 15 depicts an illustrative flowchart of a process used to determine an entity, in accordance with some embodiments of the disclosure;

FIG. 16 depicts an illustrative example of the architecture used to provide search, recommendation, and discovery features, in accordance with some embodiments of the disclosure.

### DETAILED DESCRIPTION

Methods and systems are described herein for using a combination of semantic graphs and machine learning to automatically generate structured data, recognize important entities/keywords, and create weighted connections generating more relevant search results and recommendations. For example, by inferring relevant entities, metadata results are richer and more meaningful, enabling faster decision-making for the consumer and stronger viewership for the content owner.

As referred to herein, a semantic graph may be a network that represents semantic relationships between concepts. In particular, the semantic graph described herein may represent semantic relationships between different parts of speech. For example, in this network the semantic graph may consists of vertices that correspond to concepts and edges, which represent semantic relations between the concepts.

For example, in the semantic graph the concepts may include each of the eight parts of speech (e.g., nouns, verbs, adjectives, adverbs, prepositions, conjunctions, including coordinating conjunctions, subordinating conjunctions, conjunctive adverbs, correlative conjunctions, and/or interjections). These parts of speech, and metadata indicating the part of speech for each word of the semantic graph (i.e., the concept) are used by the system to determine how words (e.g., representing nodes in the graph) are joined together to make sentences that are interpretable. The joins between these words are then ranked to interpret a query posed to the system (e.g., by a user) as well as generate a response to the query.

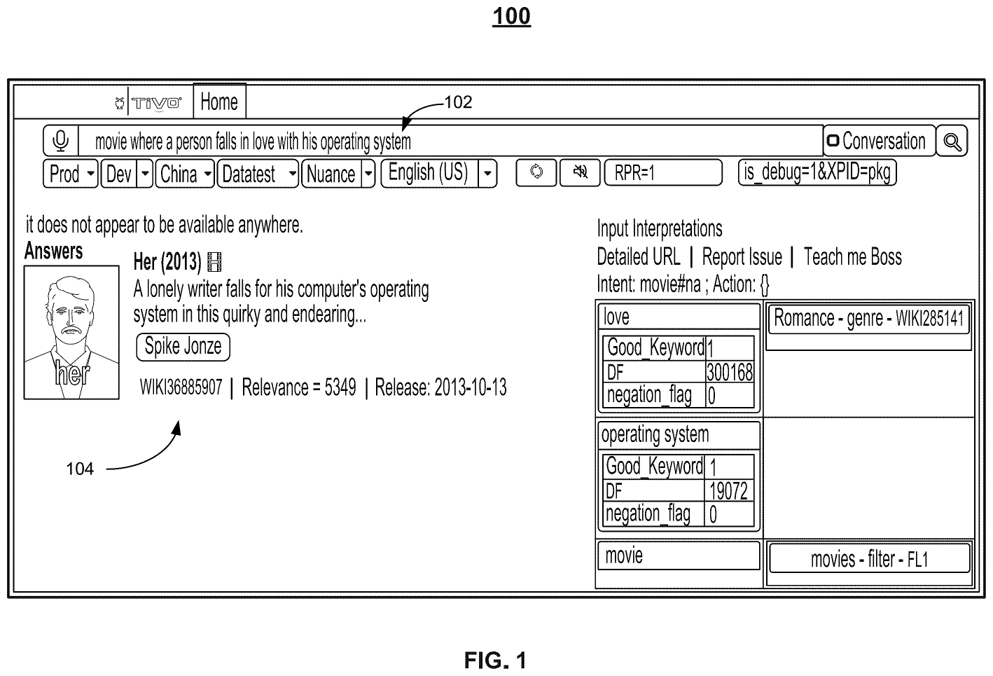

FIG. 1 illustrates an application of the methods and systems. In FIG. 1, user interface 100 is displayed on a display device. User interface 100 has received text string 102 (e.g., via a user input into a user input interface). In response, the system has generated for display program recommendation 104. The following example illustrates how keywords from semantic graphs demonstrate deeper understanding of content and provide a richer search experience. For example, for text string 102 (“movie where a person falls in love with an operating system”), the system via the semantic graph returns program recommendation 102, which corresponds to the movie “Her.” In this embodiment, the semantic graph is built based on a dataset comprising keywords and descriptions from plot details of media content. It should be noted that the dataset could comprise any type of data from any data source and/or based on any particular subject matter. In FIG. 1, the system has determined that the words “love” and “operating system” in text string 102 are highly relevant and contextual keywords. The system flags the semantic keywords as “Good_Keyword” and indexes these keywords with higher weight in the search system.

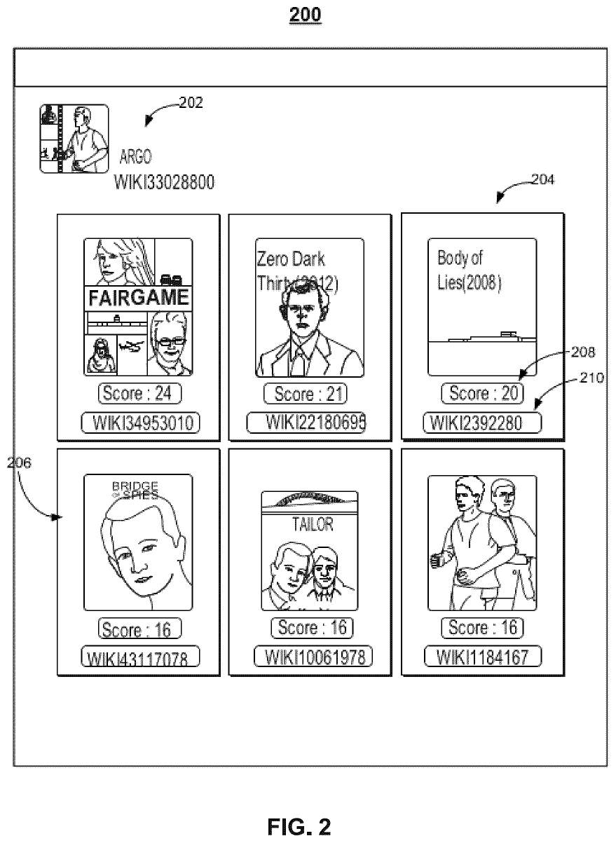

FIG. 2 illustrates another application of the methods and systems. In FIG. 2, user interface 200 is displayed on a display device. User interface 200 has received text string 202 (e.g., via a user input into a user input interface), which corresponds to the movie “Argo.” For example, in response to a user request, the system may recommend other content that shares similar characteristics to “Argo.” In response, the system has generated for display program recommendations 204 and 206. Additionally, the system has generated scores for each of the similar movies. For example, program recommendation 204 includes score 208. Additionally or alternatively, the system may generate links to access programs corresponding to the program recommendation. For example, FIG. 2 includes link 210, which is a link to access the program corresponding to program recommendation 204.

In FIG. 2, the entities (e.g., program recommendations 204 and 206) are considered as semantic concepts and similarities of entities are used in recommendations. For example, in the movie, “Argo,” “CIA,” “thriller,” and “war” are important subject matter, genre, and thematic concepts. The system leverages one or more of these and recommends similar movies like “Fair Game,” and “Syriana.” For example, the semantic graph described herein weights the most important nodes from the unstructured text (e.g., metadata for media content) to improve the search results. In contrast, keywords extracted from models driven by statistical methods like term frequency-inverse document frequency (“TF-IDF”) do not distinguish contextual elements from irrelevant ones. TF-IDF is a numerical statistic that is intended to reflect how important a word is to a document in a collection or corpus. It is often used as a weighting factor in searches of information retrieval, text mining, and user modeling. The TF-IDF value increases proportionally to the number of times a word appears in the document and is offset by the number of documents in the corpus that contain the word, which helps to adjust for the fact that some words appear more frequently in general. In such cases, a generic term like “love” has a high term and document frequency, which traditional TF-IDF-based models will not consider as a good weight keyword. The semantic graph approach, in contrast, improves upon conventional statistics by measuring the relevance of the keyword based on the contextual importance. The determination of the contextual importance is based on the position of the keyword in the semantic graph and the connections between that keyword and other concepts, as discussed below.

It should be noted that semantic graph features can be applied to a variety of content, not just media assets such as movies and television programs, but also news articles, short-form content and even one-time events, such as award shows. In fact, the semantic graph feature may be applied to any media asset. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed, or accessed by user equipment devices, but can also be part of a live performance.

For any of these media assets, the information determined from the semantic graph can be applied in improving the discovery of content and can create relevant results and meaningful recommendations for consumers. Additionally or alternatively, the semantic graphs may be used, by the system, for trending topic identification. For example, the system may extract trending topics from unstructured sources like Google News. For example, from a news article, the system may highlight the most relevant entities and suppress noisy entities of fleeting mention, and the semantic graph's node-scoring mechanism may evaluate the most relevant entities.

Additionally or alternatively, the semantic graphs may be used, by the system, for named entity extraction. For example, the system may locate and classify named entities in text into predefined categories such as the names of persons, organizations, locations, expressions of times, quantities, monetary values, percentages, etc. The system may then automatically extract the contextually important entities or keywords from the unstructured text (e.g., news article, content description) for content discovery.

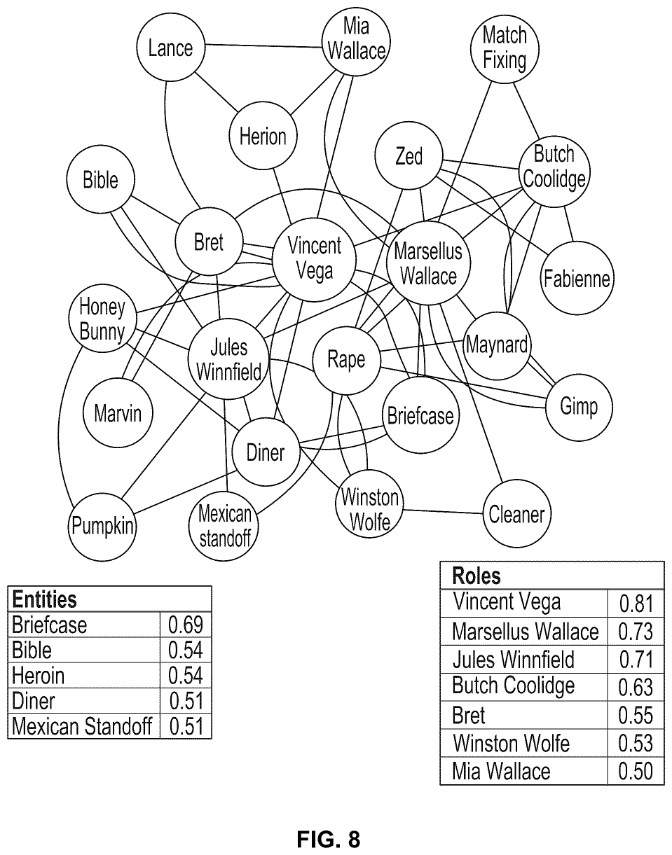

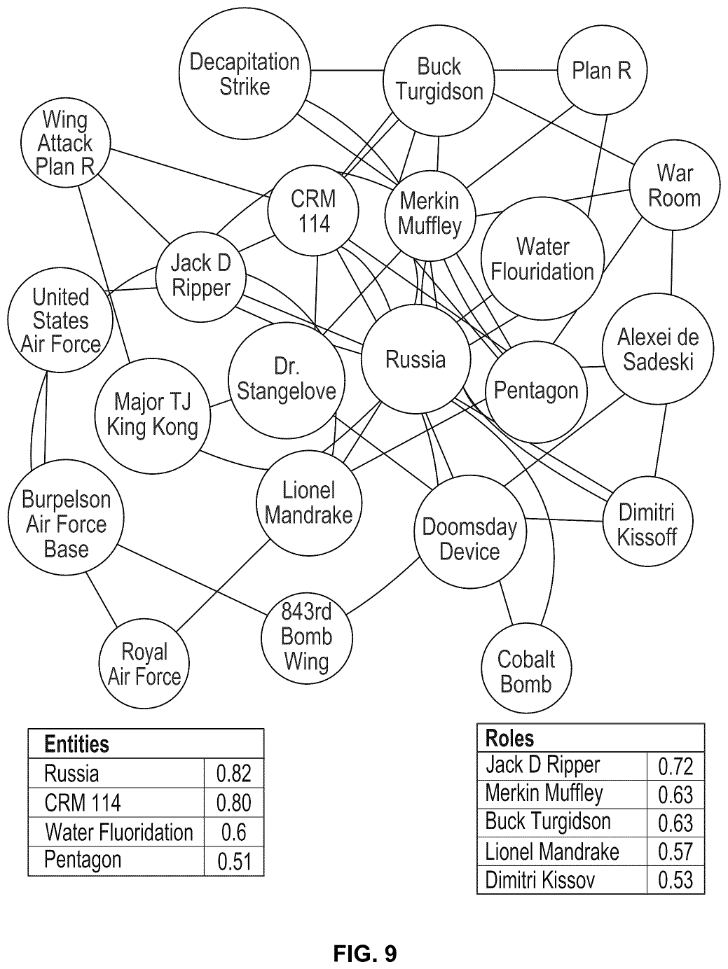

Additionally or alternatively, the semantic graphs may be used, by the system, for role importance, which is the classification of important and unimportant cast members and roles in content based on the node score from the semantic graph. For example, in FIGS. 8 and 9, important roles determined to achieve a high score are shown. These important roles may be displayed in the displays of FIGS. 1-2.

It should also be noted that the system may use semantic graphs in combination with machine learning to gain a deeper understanding of content, quickly identifying relevant entities/keywords based on context and extending entertainment discovery beyond sometimes exhausting “search and find” methods. Accordingly, viewers are no longer tied to remembering an exact title or character, but can instead use natural language to find the content they are interested in. This foundation for contextually relevant, voice-powered search results and recommendations satisfies consumers' desire to quickly find the right content and allows content owners to increase viewership of their long-tail catalogues.

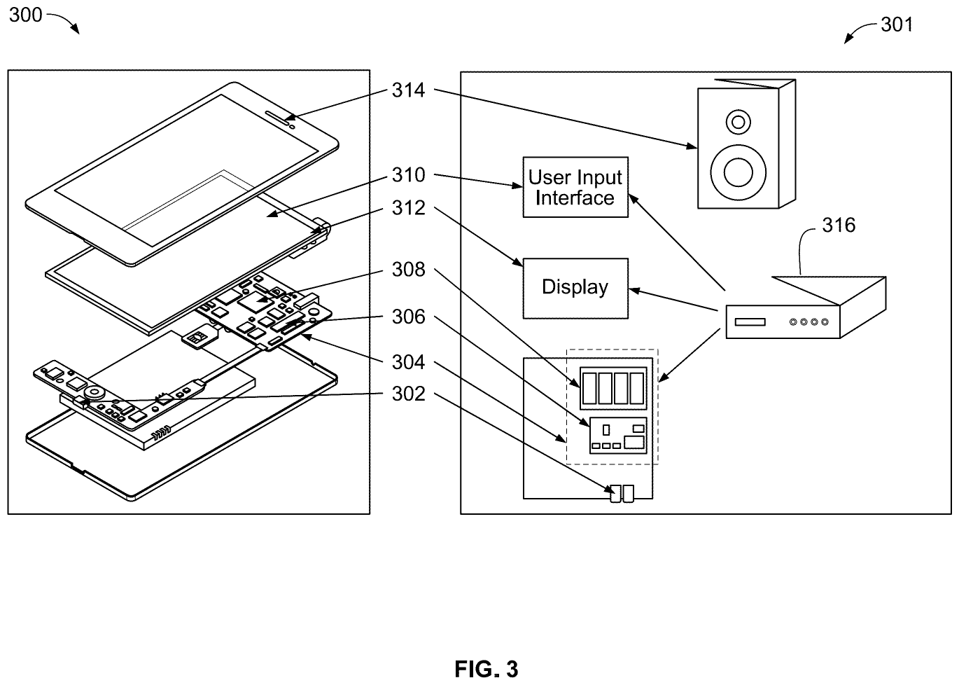

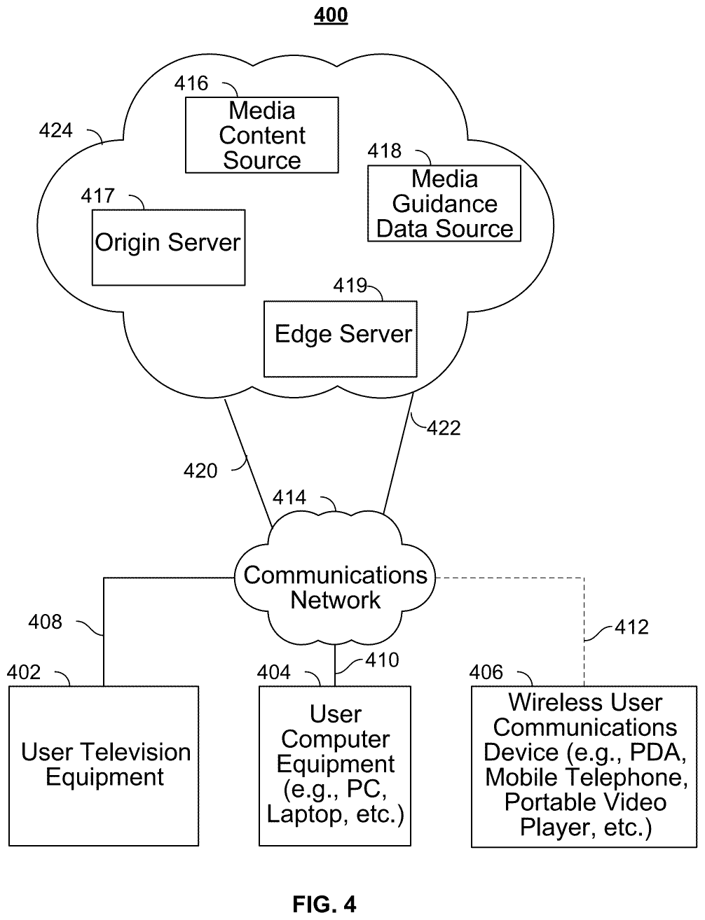

FIG. 3 shows generalized embodiments of illustrative user equipment device 300, which may provide search, recommendation, and discovery features discussed herein. For example, user equipment device 300 may be a smartphone device or a remote control. In another example, user equipment system 301 may be a user television equipment system. In such cases, the devices may store a semantic graph in their memory and/or access a semantic graph in order to process a request. User television equipment system 301 may include a set-top box 316. Set-top box 316 may be communicatively connected to speaker 314 and display 312. In some embodiments, display 312 may be a television display or a computer display. In some embodiments, set-top box 316 may be communicatively connected to user interface input 310. In some embodiments, user interface input 310 may be a remote control device. Set-top box 316 may include one or more circuit boards. In some embodiments, the circuit boards may include processing circuitry, control circuitry, and storage (e.g., RAM, ROM, Hard Disk, Removable Disk, etc.). In some embodiments, circuit boards may include an input/output path. More specific implementations of user equipment devices are discussed below in connection with FIG. 4. Each one of user equipment device 300 and user equipment system 301 may receive content and data via input/output (hereinafter I/O) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for an application stored in memory (e.g., storage 308). Specifically, control circuitry 304 may be instructed by the application to perform the functions discussed above and below. For example, the application may provide instructions to control circuitry 304 to generate the media guidance displays. In some implementations, any action performed by control circuitry 304 may be based on instructions received from the application.

In client/server-based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308, which is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video-generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of each one of user equipment device 300 and user equipment system 301. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of each one of user equipment device 300 and user equipment system 301 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on each one of user equipment device 300 and user equipment system 301. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the application is a client/server-based application. Data for use by a thick or thin client implemented on each one of user equipment device 300 and user equipment system 301 is retrieved on-demand by issuing requests to a server remote to each one of user equipment device 300 and user equipment system 301. In one example of a client/server-based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

Each one of user equipment device 300 and user equipment system 301 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices and may be substantially similar to user equipment devices described above. User equipment devices, on which an application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device, but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.Tivo.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or different types of user equipment devices. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path, and paths 408 and 410 are drawn as solid lines to indicate they are wired paths (although these paths may be wireless paths, if desired). Communications with the user equipment devices may be provided by one or more of these communications paths but are shown as a single path to and from each device in FIG. 4 to avoid overcomplicating the drawing.

Although communications paths are not drawn between user equipment devices, these devices may communicate directly with each other via communications paths, such as those described above in connection with paths 408, 410, and 412, as well as other short-range point-to-point communications paths, such as USB cables, IEEE 1394 cables, wireless paths (e.g., Bluetooth, infrared, IEEE 402-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes a remote network 424. Remote network 424 may be a cloud-based network, which includes a plurality of servers and devices for content delivery. For example, remote network 424 may include an origin server 417 and an edge server 419. For example, a content delivery network (CDN) may have edge servers store (cache) content in strategic locations in order to take the load off of one or more origin servers. By moving static assets like images, HTML and JavaScript files (and potentially other content) as close as possible to the requesting client machine, an edge server cache is able to reduce the amount of time it takes for a web resource to load. System 400 includes content source 416 and media guidance data source 418 coupled to communications network 414 via communications paths 420 and 422, respectively. Paths 420 and 422 may include any of the communication paths described above in connection with paths 408, 410, and 412. Communications with the content source 416 and media guidance data source 418 may be exchanged over one or more communications paths but are shown as paths 420 and 422 in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client/server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the application itself or software updates for the application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the application may generate promotions that entice the user to keep the particular service or source indicated by the score as one to which the user will likely terminate access.

Applications may be, for example, stand-alone applications implemented on user equipment devices. For example, the application may be implemented as software or a set of executable instructions which may be stored in storage 308 and executed by control circuitry 304 of each one of user equipment device 300 and user equipment system 301. In some embodiments, applications may be client/server applications where only a client application resides on the user equipment device, and a server application resides on a remote server. For example, applications may be implemented partially as a client application on control circuitry 304 of each one of user equipment device 300 and user equipment system 301 and partially on a remote server as a server application (e.g., media guidance data source 418) running on control circuitry of the remote server. When executed by control circuitry of the remote server (such as media guidance data source 418), the application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute applications (e.g., web-based applications or cloud-based applications), or the content can be displayed by applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent application settings on different user equipment devices within a home network, as described in greater detail in Ellis et al., U.S. Patent Publication No. 2005/0251827, filed Jul. 11, 2005, which is hereby incorporated by reference in its entirety. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via an application implemented on a remote device. For example, users may access an online application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with an application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their application to communicate directly with content source 416 to access content. Specifically, within a home, users of user television equipment 402 and user computer equipment 404 may access the application to navigate among and locate desirable content. Users may also access the application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having a content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, an application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

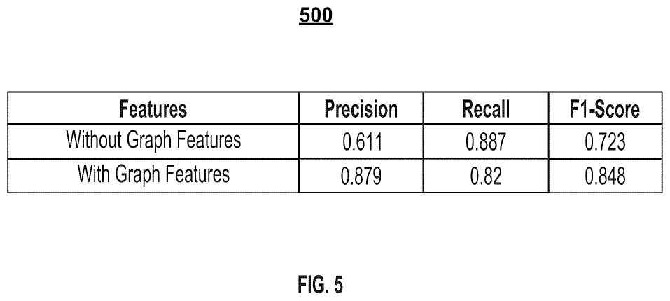

The methods and systems described herein use a combination of semantic graphs and machine learning to automatically generate structured data, recognize important entities/keywords, and create weighted connections generating more relevant search results and recommendations. An example of the rate at which more relevant search results and recommendations are achieved is shown in FIG. 5. FIG. 5 is a results table (table 500) for an exemplary model with a test split of a manually curated list of the top 10,000 movies. Included in the table are the precision, recall, and F1 scores when a decision tree classifier was run with and without graph features. An F1 score is a measure of the accuracy of a test performed by considering the precision and recall (as described below). Precision is the number of correct positive results divided by the number of all positive results returned by a classifier. Recall is the number of correct positive results divided by the number of all relevant samples (all samples that should have been identified as positive). The harmonic average of precision and recall is then taken to create the F1 score. An F1 scores range from 1 (indicating perfect precision and recall) to 0. As shown, the recall is higher in the model without graph features, and precision is low as expected, because the model without graph feature is unable to distinguish between high-quality and low-quality entities. Thus, by using the semantic graphs discussed herein, search, recommendation, and discovery features are able to obtain results with higher precision and F1 scores. For example, using the semantic graph, the system can rank entities (e.g., a keyword in or about a movie, an object in the movie, a key plot point, etc.) in order to return more relevant requests, but also to determine the universe of entities that are relevant to a given keyword. The entities may correspond to nodes in the semantic graph and each of these nodes may be more highly or lowly rated.

In FIG. 5, the system measures the precision and recall of the model by comparing its results with a manually curated list of entities. The system defines precision as the proportion of the number of machine-generated entities that match the manually curated list (N) to the total number of machine-generated entities (K).

$$precision = \frac{N}{K}$$

Recall is measured, by the system, as the proportion of manually-curated entities that are extracted by the model (N) to the number of manually-curated entities (M).

$$recall = \frac{N}{M}$$

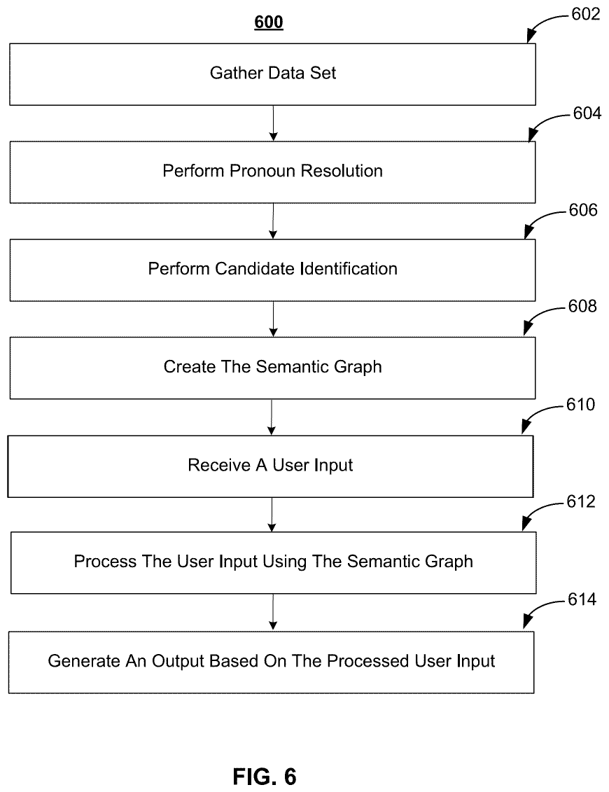

FIG. 6 is an illustrative example of the architecture used to provide the search, recommendation, and discovery features described herein. As shown in FIG. 6, the system gathers a data set and generates a semantic graph that identifies key entities and their associations. The features from the semantic graph and the data set flow through the machine-learning model to infer the most contextually important entities. The process involves four stages: pronoun resolution, candidate identification, creation of a semantic graph, and processing of a user input.

At step 602, the system gathers a data set. For example, the user may input text strings from a known data set. Additionally or alternatively, the system may use a web crawler to gather data to populate the data set. In some embodiments, in order to build the semantic graph, the system is trained on a specific dataset. The dataset is chosen based on the likely inputs that the system will receive. In particular, the system is trained on data that is reflective of typical conversational user tone. To obtain dialogue featuring the proper tone, the data set selected is based on data sets featuring particular criteria such as content based on user collaboration and user-generated/modified content. In some embodiments, content is further selected from forums featuring simplified markup languages in order to case data gathering. For example, the system may pull data from a wiki website. By using data from these sources, the system can improve the training of the model to reflect the typical tone of requests from users.

Additionally or alternatively, the system is trained on data that is reflective of typical conversational content of user queries. In particular, the system may pull its data set from the wiki plot sections, synopsis sections, category references in the plot sections, and noun chunks from the plot. By using these specific types of data, the system can improve the training of the model to reflect the typical content of requests from users.

The data set can then be divided into a 70:30 ratio of training data to validation data to build the training model. For example, the model may be trained on the training dataset. The training data set represents the parameters (e.g., weights of connections between nodes in the semantic graph) of the model such as recognizing important entities/keywords for, and creating weighted connections to, search results and recommendations. The model (e.g., a neural net or a naive Bayes classifier) is then trained on the training dataset using a supervised learning method (e.g., gradient descent or stochastic gradient descent). For example, the system may determine whether or not inferred entities are relevant to a given search request. As the model is trained on the training dataset and produces results, the system can compare the results to the actual result (or target results). Based on the actual result of the comparison and the specific learning algorithm being used, the parameters of the model are adjusted. Through an iterative process, the system fits the trained model to predict important entities/keywords that may be found in user search queries to search results and recommendations.

At step 604, the system performs pronoun resolution. Pronoun resolution is important for identifying the entity relationships necessary to rich, accurate semantic graphs. In this step of the process, the system resolves all the pronouns across sentences in the text string. For example, the system may use a Python implementation of end-to-end neural coreference resolution, which allows for determining the noun or proper noun (e.g., “noun chunk”) to which the pronoun refers.

A coreference occurs when two or more expressions (e.g., pronouns, phrases, objects, etc.) in a text refer to the same thing (e.g., a proper noun). For example, in the text string “Bill said he would come,” the proper noun “Bill” and the pronoun “he” refer to the same person-Bill. Coreference is the main concept underlying binding phenomena in the field of syntax. In some embodiments, the system may develop a neural network for resolving pronouns. For example, the system, via control circuitry 304, may receive the text string “John helped Mary. He is a doctor.” The system may resolve the pronouns, to create a resolved text string, “John helped Mary. John is a doctor.”

In traditional systems, a system first reviews an input document to detect mentions of entities (e.g., pronouns). The system then clusters the entities (e.g., pronouns) such that each pronoun cluster corresponds to the same proper noun. To perform these steps the system may rely on a parser and pre-processing, for detection and clustering. In an end-to-end neural coreferencing, the system will consider all spans between entities, will rank the spans between entities, and create a factored model to prune search spaces. The system may then detect, with high probability, the noun chunk to which a given pronoun refers.

For span ranking, the system will process each span in the input document and assign an antecedent to every span. In some cases, the system creates implicit spans. The resulting cluster will cause the system to identify spans of three types: i) spans with no previously mentions; ii) mentions with no previous links; and iii) spans with a predicted coreference link. For each span, the system will make an independent decision and apply a pairwise coreference score that will determine the likelihood of a coreference between two spans. The system will then determine the antecedent based on the pair with the highest score. Additional discussion on end-to-end coreferencing can be found in Lee et. al., 2017, End-to-end Neural Coreference Resolution, In Proceedings of Empirical Methods in Natural Language Processing (EMNLP 2017), pp. 188-197, which is hereby incorporated by reference in its entirety.

At step 606, the system performs (e.g., via control circuitry 304) candidate identification. For example, the system may apply POS (Part-Of-Speech) tagging on the processed text to identify all noun chunks as nodes in the semantic graph. Part-of-speech tagging (POS tagging or PoS tagging or POST), also called grammatical tagging or word-category disambiguation, is the process of marking up a word in a text (corpus) as corresponding to a particular part of speech, based on both its definition and its context (i.e., its relationship with adjacent and related words in a phrase, sentence, or paragraph).

For example, in order to build the semantic graph the system may determine the word-category for each word in a text. The word-categories may include each of the eight parts of speech (e.g., nouns, verbs, adjectives, adverbs, prepositions, conjunctions, including coordinating conjunctions, subordinating conjunctions, conjunctive adverbs, correlative conjunctions, and/or interjections. These parts of speech, and metadata indicating the part of speech for each word of the semantic graph (i.e., the concept) are used by the system to determine how words (e.g., representing nodes in the graph) are joined together to make sentences that are interpretable. In some embodiments, POS tagging is done in the context of computational linguistics, using algorithms which associate discrete terms, as well as hidden parts of speech, in accordance with a set of descriptive tags. POS-tagging algorithms fall into two distinctive groups: rule-based and stochastic. For rule-based POS tagging, the system is manually built through a series of manual rules. For example, the system may include a rule indicating that a word preceding a tagged word is tagged in a particular way through if-then statements. Statistical (or stochastic) part-of-speech tagging assumes that each word is known and has a finite set of possible tags. These tags can be drawn from a dictionary or a morphological analysis. For example, when a word has more than one possible tag, the system may use statistical methods to determine the sequence of part-of-speech tags. The system may also use a hybrid approach that combines the rule-based and stochastic. Finally, it should be noted in some embodiments, POS tagging may be performed manually.

To perform the POS tagging, the system may use a software library for advanced Natural Language processing. In some embodiments, the system may use SpaCy, a Python library for advanced Natural Language Processing, to power identification through its POS tagging ability. In addition to POS tagging, the system may use additional features such as non-destructive tokenization, named entity recognition, statistical models for multiple languages, pre-trained word vectors, labelled dependency parsing, syntax-driven sentence segmentation, text classification, built-in visualizers for syntax and named entities, and/or deep learning integration.

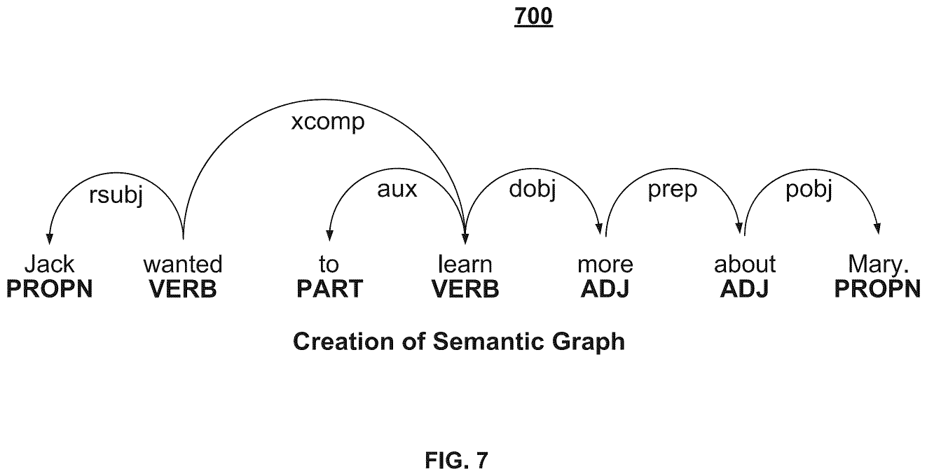

At step 608, the system creates a semantic graph. The semantic graph is a knowledge base that represents semantic relations between concepts in a network. The system uses the semantic graph as a form of knowledge representation. It is a directed (e.g., graph that is made up of a set of vertices connected by edges, where the edges have a direction associated with them) and/or undirected graph consisting of nodes, which may represent concepts and/or entities, and edges, which represent semantic relations between concepts and/or entities. FIG. 7, discussed below, provides an exemplary semantic graph. For example, for each of the candidates (e.g., “Jack”, “doctor”, etc.) appearing in the text string (“Jack is a doctor.”), the semantic graph may indicate the relationships between these terms. In such an example, the candidates may represent the vertices in the semantic graphs, while relationship between the candidates (e.g., “is”) are represented by the edges of the semantic graph. Furthermore, in a second textual string (e.g., “He has an office on First Street.”), the semantic graph may indicate the relationships between the term “he” and “Jack”. The relationships between these terms may be found by traversing a dependency tree with the interweaving dependency trees (as created based on the POS tagging) creating the semantic network. For example, in some embodiments, the system determines that connections are via verbs, and an undirected graph (i.e., a graph in which edges have no orientation) is created using these edges. In semantic graph 700, “Jack” and “doctor” are connected by “is”. In the dependency tree “is” connects the term “Jack” and “doctor”.

In some embodiments, the dependency tree may represent the syntactic structure of a string according to some context-free grammar. The dependency tree may be constructed based on either the constituency relation of constituency grammars (phrase structure grammars) or the dependency relation of dependency grammars. The dependency tree may be generated for sentences in natural languages as well as during processing of computer languages, such as programming languages.

In some embodiments, the system trains using a Decision Tree Classifier and Random Forest Classifier. The Decision Tree Classifier is a flow-chart-like structure, where each internal (non-leaf) node denotes a test on an attribute, each branch represents the outcome of a test, and each leaf (or terminal) node holds a class label. The topmost node in a tree is the root node. The Random Forest Classifier may operate by constructing a multitude of decision trees at training time and outputting the class that is the mode of the classes (classification) or mean prediction (regression) of the individual trees. Random decision forests correct for decision trees' habit of overfitting to their training set. It should be noted that the system may implement any decision-tree algorithms.

The semantic graph is defined by the nodes of the graph. Each node is further defined by its centrality. The four types of centrality including degree, closeness, betweenness, and indegree. As opposed to the centrality of degree and indegree, the semantic graph is defined by its closeness and betweenness. For example, during computations, the system determines (e.g., via control circuitry 304) the graph features based on closeness centrality and betweenness centrality. With respect to closeness centrality, the closeness centrality (or closeness) of a node measures centrality in a network, calculated as the sum of the length of the shortest paths between the node and all other nodes in the graph. Thus, the more central a node is, the closer it is to all other nodes. The closeness centrality of a node C(x) is denoted by:

$$C ( x ) = \frac{N}{{\sum }_{y} d ( y , x )}$$

where d(y, x) is the distance between node x and y and N is the number of nodes.

With respect to betweenness centrality, “betweenness” centrality is a measure of centrality in a graph based on shortest paths. For every pair of nodes in a connected graph, there exists at least one shortest path between the nodes, such that either the number of edges that the path passes through (for unweighted graphs) or the sum of the weights of the edges (for weighted graphs) is minimized. The betweenness centrality for each node is the number of these shortest paths that pass through the vertex. Betweenness centrality g(v) is denoted by:

$$g ( v ) = {\sum }_{s , t + V} \frac{σ ( s , t / v )}{σ ( s , t )}$$

Where V is the set of nodes, σ(s, t) is the number of shortest (c, t)-paths, and σ(s, t/v) is the number of those paths passing through some node v other than s, t, where if s==t, σ(s, t)=1, and if v e s t, σ(s, t/v)=0

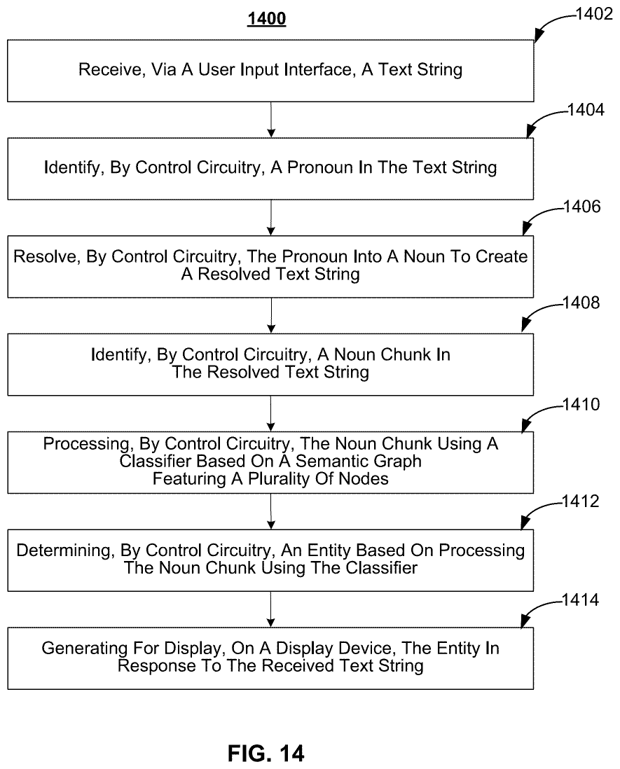

After the semantic graph is trained, the system (e.g., via control circuitry 304) may begin using the semantic graph to analyze user inputs and identify user responses. For example, this process is discussed below in relation to FIG. 14. At step 610, the system (e.g., via control circuitry 304) receives a user input. The user input may be a user utterance or a text string received through a user input interface (e.g., user input interface 310). The system may perform operations such as speech-to-text processing on user utterances to obtain text strings which correspond to the utterances. The system may further break down the user input into components, (e.g., into candidates and into the eight parts of speech) for further processing.

At step 612, the system processes the user input using the semantic graph created in step 608. The system may match candidates from the user input to nodes in the semantic graph. For example, if the user input is the text string “Jack is a doctor. He has an office on First Street,” the system may match the candidates “Jack,” “doctor,” “office,” and “First Street” to nodes in the semantic graph. Furthermore, relationship between the candidates (e.g., “is”) are represented by the edges of the semantic graph. These relationships may be indicated by words such as “is,” “has,” and “on.” The semantic graph may additionally indicate the relationships between the term “he” and “Jack”. The relationships between these terms may be found by traversing a dependency tree. In semantic graph 700, “Jack” and “doctor” are connected by “is”. In the dependency tree “is” connects the term “Jack” and “doctor”.

At step 614, the system generates an output based on the processed user input. The system may use the processing completed in step 612 to determine entities relevant to the components of the user input (e.g., the user input received at step 612). The system may traverse the semantic graph to determine nodes which are closely tied to the nodes representing the user input. For example, the system may identify nodes which bridge the gap between user input nodes. The system may compose an output which comprises the identified nodes as well as the edges which connect the nodes. The output may comprise an answer to a question posed in the user input or may comprise additional information that expands upon the user input. The output may be in the form of a statement, a link to additional resources, or any other form of output.

FIG. 7 provides an exemplary semantic graph 700. For example, for each of the candidates appearing in the text string (“Jack wanted to learn more about Mary.”), the system checks whether the words in the text string are connected by traversing the dependency tree, which is created using spaCy. In some embodiments, the system determines that connections are via verbs, and an undirected graph is created using these edges. In semantic graph 700, “Jack” and “Mary” are connected by the verbs “wanted” and “learn.”

In some embodiments, the dependency tree may represent the syntactic structure of a string according to some context-free grammar. The dependency tree may be constructed based on either the constituency relation of constituency grammars (phrase structure grammars) or the dependency relation of dependency grammars. The dependency tree may be generated for sentences in natural languages as well as during processing of computer languages, such as programming languages.

The dependency tree includes part-of-speech tags for each candidate in the text string. For example, “Jack” is labelled as “PROPN” which indicates it is a proper noun. The dependency tree connects words in the dependency tree using arcs. Each arc has a “head” and a “child” indicating dependency, i.e., the child is dependent on the head. In FIG. 7, for example, “wanted” and “learn” are connected by an arc; “wanted” is the head while “learn” is the child and is therefore dependent on “wanted.” The arcs additionally indicate modification, i.e., the child modifies the head. For example, “more” is the child of “learn,” indicating that “more” modifies “learn.” Each word in the dependency tree has exactly one head. Each word may have any number of children, including no children.

Each arc may be assigned a label, indicating the type of syntactic relation that connects the child to the head. For example, in FIG. 7, “wanted” is connected to “learn” by an arc labelled “xcomp,” which indicates that “learn” is an open clausal complement of “wanted.”

The meaning of the string is therefore broken down into the part-of-speech tags and arcs indicating syntactic relations between words. Traversing through a dependency tree, such as the dependency tree in FIG. 7, reveals how the words in the string are connected.

FIGS. 8-10 show illustrative examples of entities and roles extracted by the system. The low-score nodes have been removed for easy representation. FIG. 8 corresponds to the movie “Pulp Fiction.” The system determines that the entity “Briefcase” has a high score (as it is the McGuffin driving the plot), which would be difficult to surface with statistical models like TF-IDF. The TF-IDF score of a generic term like “Briefcase” would be very low, and the statistical model fails to grasp the semantic relevance of the phrase in the context of the movie. FIG. 9 corresponds to the movie “Dr. Strangelove.” The system has identified important entities like “Russia,” “CRM-114,” and “Water Fluoridation,” all of which would not have been extracted by traditional models. It is also observed that the roles integral to the plot of the movie receive higher scores.

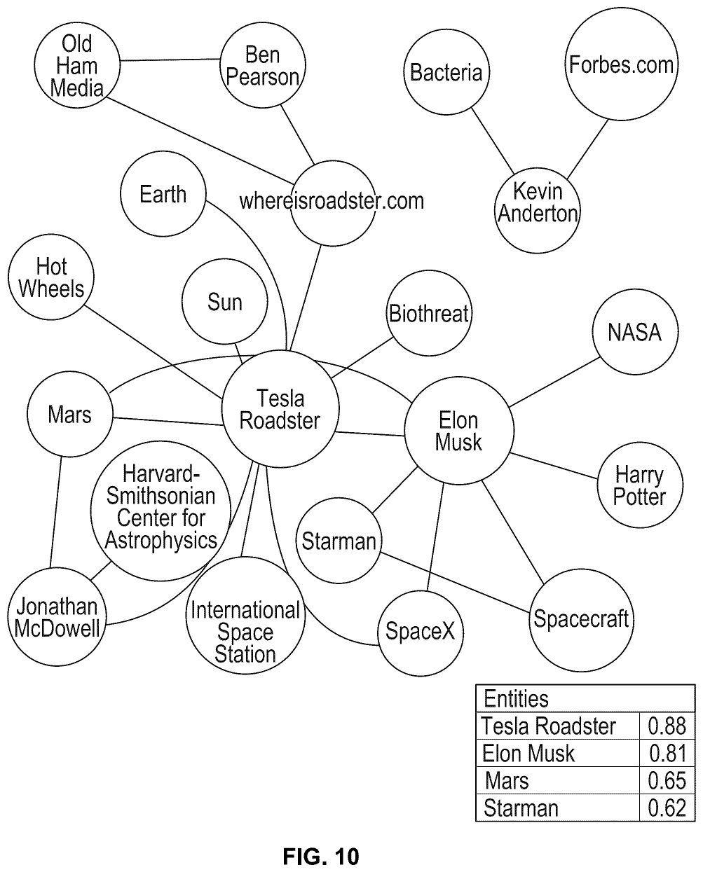

FIG. 10 is an illustrative example of the systems being applied to a news article, “Sending Tesla Roadster to Mars.” The system successfully extracted entities like “Tesla Roadster,” “Elon Musk,” “Mars” and “Starman” while removing the “noise”-unimportant keywords like “Kevin Anderson,” “bio threat,” “Harry Potter” and “bacteria.”

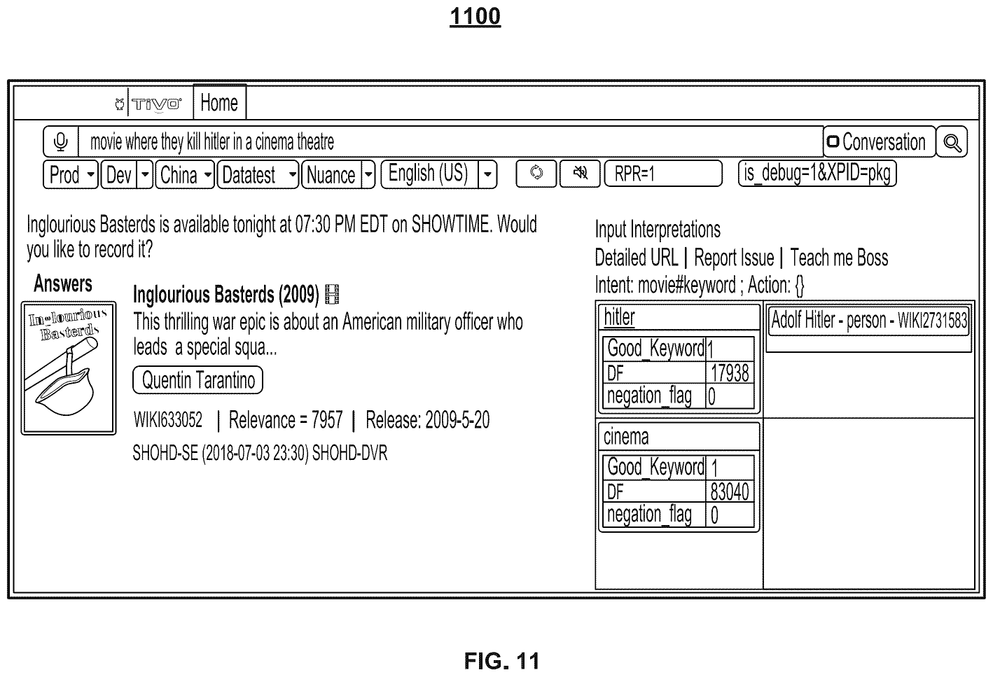

FIG. 11 illustrates an application of the methods and system corresponding to the use described in FIG. 1. In FIG. 11, user interface 1100 is displayed on a display device. User interface 1100 has received a text string (e.g., via a user input into a user input interface). In response, the system has generated for display a program recommendation. The following example illustrates how keywords from semantic graphs demonstrate deeper understanding of content and provide a richer search experience.

It should be noted that the methods and systems described herein may be implemented in the application for providing media guidance. For example, the amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

The media guidance application and/or any instructions for performing any of the embodiments discussed herein may be encoded on computer-readable media. Computer-readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smartphone, or any other television equipment, computing equipment, or wireless device, and/or combination of the same. In some embodiments, the user equipment device may have a front-facing screen and a rear-facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as online applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

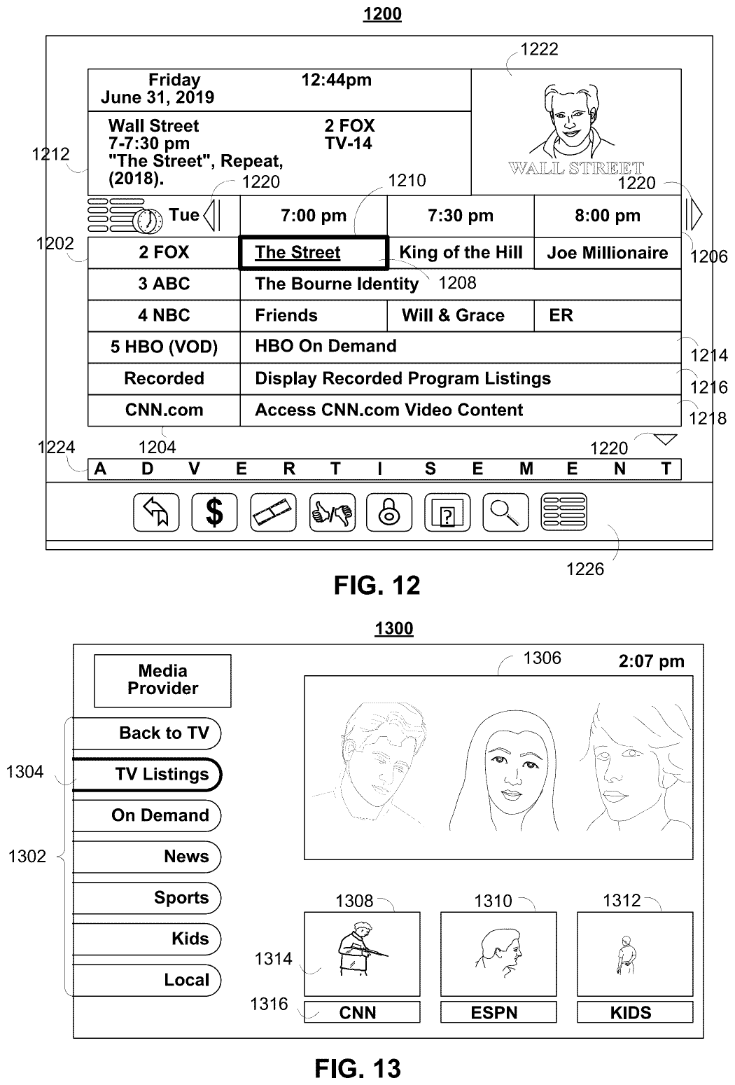

It should be noted that the techniques methods and system described herein may be applied to multiple types of user interfaces and applications. Two exemplary media guidance applications for implementing these techniques are shown in FIGS. 12-13. FIGS. 12-13 show illustrative display screens that may be used to provide media guidance data. The display screens shown in FIGS. 12-13 may be implemented on any suitable user equipment device or platform. While the displays of FIGS. 12-13 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 12 shows illustrative grid of a program listings display 1200 arranged by time and channel that also enables access to different types of content in a single display. Display 1200 may include grid 1202 with: (1) a column of channel/content type identifiers 1204, where each channel/content type identifier (which is a cell in the column) identifies a different channel or content type available; and (2) a row of time identifiers 1206, where each time identifier (which is a cell in the row) identifies a time block of programming. Grid 1202 also includes cells of program listings, such as program listing 1208, where each listing provides the title of the program provided on the listing's associated channel and time. With a user input device, a user can select program listings by moving highlight region 1210. Information relating to the program listing selected by highlight region 1210 may be provided in program information region 1212. Region 1212 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and provided according to a schedule), the media guidance application also provides access to non-linear programming (e.g., content accessible to a user equipment device at any time and not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on demand as streaming content or downloadable content through an Internet website or other Internet access (e.g., FTP).

Grid 1202 may provide media guidance data for non-linear programming including on-demand listing 1214, recorded content listing 1216, and Internet content listing 1218. A display combining media guidance data for content from different types of content sources is sometimes referred to as a “mixed-media” display. Various permutations of the types of media guidance data that may be displayed that are different from display 1200 may be based on user selection or guidance application definition (e.g., a display of only recorded and broadcast listings, only on-demand and broadcast listings, etc.). As illustrated, listings 1214, 1216, and 1218 are shown as spanning the entire time block displayed in grid 1202 to indicate that selection of these listings may provide access to a display dedicated to on-demand listings, recorded listings, or Internet listings, respectively. In some embodiments, listings for these content types may be included directly in grid 1202. Additional media guidance data may be displayed in response to the user selecting one of the navigational icons 1220. (Pressing an arrow key on a user input device may affect the display in a similar manner as selecting navigational icons 1220.)

Display 1200 may also include video region 1222, advertisement 1224, and options region 1226. Video region 1222 may allow the user to view and/or preview programs that are currently available, will be available, or were available to the user. The content of video region 1222 may correspond to, or be independent from, one of the listings displayed in grid 1202. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 1224 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 1202. Advertisement 1224 may also be for products or services related or unrelated to the content displayed in grid 1202. Advertisement 1224 may be selectable and provide further information about content; provide information about a product or a service; enable purchasing of content, a product, or a service; provide content relating to the advertisement; etc. Advertisement 1224 may be targeted based on a user's profile/preferences, monitored user activity, the type of display provided, or on other suitable targeted advertisement bases.

While advertisement 1224 is shown as rectangular or banner-shaped, advertisements may be provided in any suitable size, shape, and location in a guidance application display. For example, advertisement 1224 may be provided as a rectangular shape that is horizontally adjacent to grid 1202. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 1226 may allow the user to access different types of content, media guidance application displays, and/or media guidance application features. Options region 1226 may be part of display 1200 (and other display screens described herein) or may be invoked by a user by selecting an on-screen option or pressing a dedicated or assignable button on a user input device. The selectable options within options region 1226 may concern features related to program listings in grid 1202 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, email, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.Tivo.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. Additional personalized media guidance application features are described in greater detail in Ellis et al., U.S. Patent Application Publication No. 2005/0251827, filed Jul. 11, 2005; Boyer et al., U.S. Pat. No. 7,165,098, issued Jan. 16, 2007; and Ellis et al., U.S. Patent Application Publication No. 2002/0174430, filed Feb. 21, 2002, which are hereby incorporated by reference herein in their entireties.

Another display arrangement for providing media guidance is shown in FIG. 13. Video mosaic display 1300 includes selectable options 1302 for content information organized based on content type, genre, and/or other organization criteria. In display 1300, television listings option 1304 is selected, thus providing listings 1306, 1308, 1310, and 1312 as broadcast program listings. In display 1300 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 1308 may include more than one portion, including media portion 1314 and text portion 1316. Media portion 1314 and/or text portion 1316 may be selectable to view content in full-screen or to view information related to the content displayed in media portion 1314 (e.g., to view listings for the channel that the video is displayed on).

The listings in display 1300 are of different sizes (i.e., listing 1306 is larger than listings 1308, 1310, and 1312), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

FIG. 14 depicts an embodiment of a process for generating the entity based on the search, recommendation, and discovery features described herein. It should be noted that each step of process 1400 can be performed by control circuitry 304 (e.g., in a manner instructed to control circuitry 304 by the application) or any other system components shown in FIGS. 3-4. Control circuitry 304 may be part of user equipment (e.g., a device that may have any or all of the functionality of means for consuming content 402, system controller 404, and/or wireless communications device 406), or of a remote server separated from the user equipment by way of communications network 414 or distributed over a combination of both.

At step 1402, the system receives a text string. The text string may be received via user input interface 310. The text string may be received from a user or from another electronic device.

At step 1404, the system (e.g., via control circuitry 304) identifies pronouns in the text string. In some embodiments, POS tagging is done in the context of computational linguistics, using algorithms which associate discrete terms, as well as hidden parts of speech, in accordance with a set of descriptive tags. POS-tagging algorithms fall into two distinctive groups: rule-based and stochastic. For rule-based POS tagging, the system is manually built through a series of manual rules. For example, the system may include a rule indicating that a word preceding a tagged word is tagged in a particular way through if-then statements. Statistical (or stochastic) part-of-speech tagging assumes that each word is known and has a finite set of possible tags. These tags can be drawn from a dictionary or a morphological analysis. For example, when a word has more than one possible tag, the system may use statistical methods to determine the sequence of part-of-speech tags. The system may also use a hybrid approach that combines the rule-based and stochastic. Finally, it should be noted in some embodiments, POS tagging may be performed manually.

To perform the POS tagging, the system may use a software library for advanced Natural Language processing. In some embodiments, the system may use SpaCy, a Python library for advanced Natural Language Processing, to power identification through its POS tagging ability. In addition to POS tagging, the system may use additional features such as non-destructive tokenization, named entity recognition, statistical models for multiple languages, pre-trained word vectors, labelled dependency parsing, syntax-driven sentence segmentation, text classification, built-in visualizers for syntax and named entities, and/or deep learning integration.

At step 1406, the system performs pronoun resolution. Specifically, the system resolves the pronoun into a noun to create a resolved text string. Pronoun resolution is important for identifying the entity relationships necessary to rich, accurate semantic graphs. In this step of the process, the system resolves all the pronouns across sentences in the text string. For example, the system may use a Python implementation of end-to-end neural coreference resolution, which allows for determining the noun or proper noun (e.g., “noun chunk”) to which the pronoun refers. In an end-to-end neural coreferencing, the system will consider all spans between entities, will rank the spans between entities, and create a factored model to prune search spaces. The system may then detect, with high probability, the noun chunk to which a given pronoun refers.

For span ranking, the system will process each span in the input document and assign an antecedent to every span. In some cases, the system creates implicit spans. The resulting cluster will cause the system to identify spans of three types: i) spans with no previously mentions; ii) mentions with no previous links; and iii) spans with a predicted coreference link. For each span, the system will make an independent decision and apply a pairwise coreference score that will determine the likelihood of a coreference between two spans. The system will then determine the antecedent based on the pair with the highest score.

At step 1408, the system identifies (e.g., via control circuitry 304) a noun chunk in the resolved text string. For example, the system may apply POS (Part-Of-Speech) tagging on the processed text to identify all noun chunks as nodes in the semantic graph as discussed above in connection with FIG. 6. It should be noted that, in some embodiments, POS tagging may be performed manually.

At step 1410, the system processes the identified noun chunk using a classifier based on a semantic graph featuring a plurality of nodes. As discussed above in greater detail in connection with FIG. 6, the semantic graph is a knowledge base that represents semantic relations between concepts in a network. The system uses the semantic graph as a form of knowledge representation. It is a directed and/or undirected graph consisting of nodes, which may represent concepts and/or entities, and edges, which represent semantic relations between concepts and/or entities. An exemplary semantic graph is discussed above in connection with FIG. 7.

For example, the system may determine (e.g., via control circuitry 304) the text features. The text features may include: a POS tag of the candidate the system extracted using spaCy; the TF-IDF (Term Frequency-Inverse Document Frequency) value of the candidate calculated over the plot of the dataset; capitalization of the candidate in the text blurb; whether the candidate has a link to another data source (e.g., website) in the metadata (otherwise set to false); whether the candidate is mentioned as a category for the relevant subject matter (otherwise set to false); whether the candidate is mentioned in a first paragraph and/or prominent position in a data source (otherwise set to false); type of candidate and/or the type of page as tagged using first line and categories tagged into seven types-programs, people, fictional, place, organization, sports, and phrase (with a default type for any candidate).

In some embodiments, high-quality information is derived through the devising of patterns and trends through means such as statistical pattern learning. Determining the text features may include the process of structuring the input text (usually parsing, along with the addition of some derived linguistic features and the removal of others, and subsequent insertion into a database), deriving patterns within the structured data, and, finally, evaluation and interpretation of the output. It should be noted that “high quality” in text features may refer to some combination of relevance, novelty, and interestingness. Typical text features may include text categorization, text clustering, concept/entity extraction, production of granular taxonomies, sentiment analysis, document summarization, and entity-relation modeling (i.e., learning relations between named entities). In some embodiments, text analysis involves information retrieval, lexical analysis to study word frequency distributions, pattern recognition, tagging/annotation, information extraction, data-mining techniques including link and association analysis, visualization, and predictive analytics.

The system may then score (e.g., via control circuitry 304) the nodes. In some embodiments with many connected components, the system computes these features on each connected component separately. The system may use the model resulting from the process of FIG. 6 above.

At step 1412, the system (e.g., via control circuitry 304) determines the entities based on processing the noun chunk using the classifier in step 1410. An exemplary process for determining the entities based on processing the noun chunk using the classifier is discussed above in connection with FIG. 6. At step 1414, the system generates for display (e.g., on display device 312) the entity in response to the received text string.

It should be noted that this embodiment can be combined with any other embodiment in this description and that process 1400 is not limited to the devices or control components used to illustrate process 1400 in this embodiment.

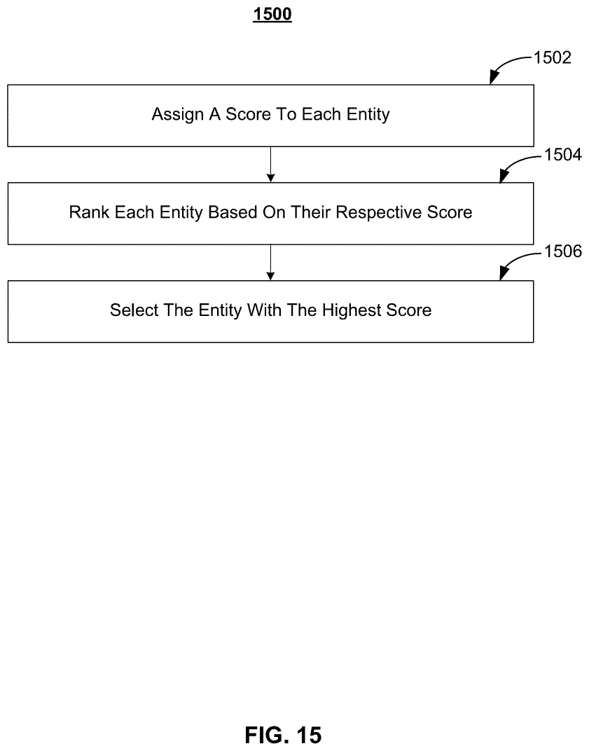

FIG. 15 depicts an embodiment of a process for determining an entity based on processing the noun chunk using the classifier, as described herein. It should be noted that each step of process 1500 can be performed by control circuitry 304 (e.g., in a manner instructed to control circuitry 304 by the application) or any other system components shown in FIGS. 3-4. Control circuitry 304 may be part of user equipment (e.g., a device that may have any or all of the functionality of means for consuming content 402, system controller 404, and/or wireless communications device 406), or of a remote server separated from the user equipment by way of communications network 414, or distributed over a combination of both.

At step 1502, the system (e.g., via control circuitry 304) assigns a score to each entity. For example, the semantic graphs may be used, by the system, for role importance, which is the classification of important and unimportant cast members and roles in content based on the node score from the semantic graph. For example, in FIGS. 8 and 9, important roles determined to achieve a high score are shown.

At step 1504, the system ranks each of the entities based on its respective score. At step 1506, the entity having the highest score is determined to correspond to the received text string. Specific examples discussing the scoring and ranking mechanism are described above in greater detail in connection with FIG. 6.

It should be noted that this embodiment can be combined with any other embodiment in this description and that process 1500 is not limited to the devices or control components used to illustrate process 1500 in this embodiment.

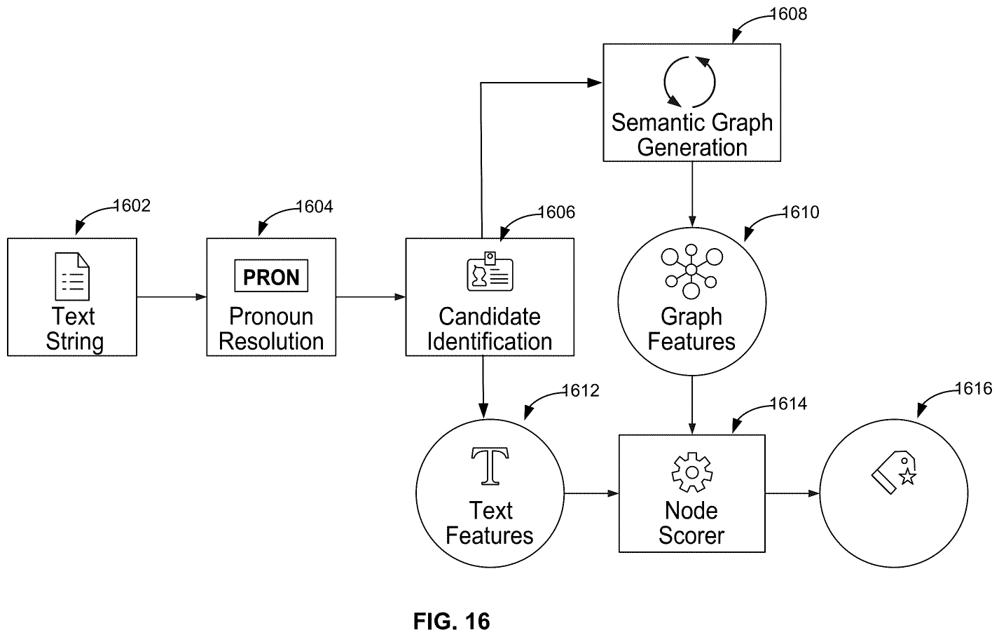

FIG. 16 is an illustrative example of the architecture used to provide the search, recommendation, and discovery features descried herein. As shown in FIG. 16, the system receives a text string as input and converts it into a semantic graph that identifies key entities and their associations. The features from the semantic graph and the text string flow through the machine-learning model to infer the most contextually important entities. The process involves four stages: pronoun resolution, candidate identification, creation of a semantic graph, and node scoring.

At step 1602, the system receives a text string. The text string may be received via user input interface 310. The text string may be received from a user or from another electronic device.

At step 1604, the system performs pronoun resolution. Pronoun resolution is important for identifying the entity relationships necessary to rich, accurate semantic graphs. In this step of the process, the system resolves all the pronouns across sentences in the text string. For example, the system may use a Python implementation of end-to-end neural coreference resolution, which allows for determining the noun or proper noun (e.g., “noun chunks”) to which the pronoun refers.

For example, coreference occurs when two or more expressions in a text refer to the same person or thing; they have the same referent. For example, in the text string “Bill said he would come”; the proper noun “Bill” and the pronoun “he” refers to the same person, namely to “Bill”. Coreference is the main concept underlying binding phenomena in the field of syntax. The theory of binding explores the syntactic relationship that exists between coreferential expressions in sentences and texts. In some embodiments, the system may develop a neural network for resolving pronouns. For example, the system, via control circuitry 304, may receive the text string “John helped Mary. He is a doctor.” The system may resolve the pronouns, to create a resolved text string, “John helped Mary. John is a doctor.”

At step 1606, the system performs (e.g., via control circuitry 304) candidate identification. For example, the system may apply POS (Part-Of-Speech) tagging on the processed text to identify all noun chunks as nodes in the semantic graph. Part-of-speech tagging (POS tagging or PoS tagging or POST), also called grammatical tagging or word-category disambiguation, is the process of marking up a word in a text (corpus) as corresponding to a particular part of speech, based on both its definition and its context—i.e., its relationship with adjacent and related words in a phrase, sentence, or paragraph. For example, the application may identify the words in a text string as nouns, verbs, adjectives, adverbs, etc. In some embodiments, POS tagging is done in the context of computational linguistics, using algorithms which associate discrete terms, as well as hidden parts of speech, in accordance with a set of descriptive tags. POS-tagging algorithms fall into two distinctive groups: rule-based and stochastic. E. Brill's tagger, one of the first and most widely used English POS-taggers, employs rule-based algorithms. It should be noted in some embodiments, POS tagging may be performed manually.

In some embodiments, the system may use SpaCy, a Python library for advanced Natural Language Processing, to power identification through its POS tagging ability. Accordingly, the system leverages its rich structure to identify more candidates like links from plot, synopsis and category mentions.

At step '608, the system creates a semantic graph. The semantic graph is a knowledge base that represents semantic relations between concepts in a network. The system uses the semantic graph as a form of knowledge representation. It is a directed and/or undirected graph consisting of nodes, which may represent concepts and/or entities, and edges, which represent semantic relations between concepts and/or entities. FIG. 7, discussed above, provides an exemplary semantic graph.

At step 1610, the system determines (e.g., via control circuitry 304) the graph features based on closeness centrality and betweenness centrality. With respect to closeness centrality, the closeness centrality (or closeness) of a node measures centrality in a network, calculated as the sum of the length of the shortest paths between the node and all other nodes in the graph (e.g., as described in FIG. 6).

The dataset may be split into training and test sets in the ration of 70:30. For example, the system may take the 10,000 media content listings (e.g., based on popularity) from a data source (e.g., a website) extract candidates for entities/keywords from the metadata for the media content (e.g., plots descriptions), and manually verified them to create positive (all accepts) and negative (all rejects) labels in the dataset. The training set is used to build the model, and the test set is evaluated and used for benchmarking. The system uses machine learning to create a function that maps an input to an output based on example input-output pairs (e.g., the training data). It infers a function from labeled training data consisting of a set of training examples. In supervised learning, each example is a pair consisting of an input object (typically a vector) and a desired output value (also called the supervisory signal). The systems learning algorithm analyzes the training data and produces an inferred function, which can be used for mapping new examples. The learned algorithm can then be used correctly determine the class labels for unseen instances (e.g., user query's in a text string).

At step 1612, the system determines (e.g., via control circuitry 304) the text features. The text features may include: POS tag of the candidate the system extracted using spaCy; the TF-IDF (Term Frequency-Inverse Document Frequency) value of the candidate calculated over the plot of the dataset; capitalization of the candidate in the text blurb; whether the candidate has a link to another data source (e.g., website) in the metadata (otherwise set to false); whether the candidate is mentioned as a category for the relevant subject matter (otherwise set to false); whether the candidate is mentioned in a first paragraph and/or prominent position in a data source (otherwise set to false); type of candidate and/or the type of page as tagged using first line and categories tagged into seven types-programs, people, fictional, place, organization, sports and phrase (with a default type for any candidate).

In some embodiments, high-quality information is derived through the devising of patterns and trends through means such as statistical pattern learning. Determining the text features may include the process of structuring the input text (usually parsing, along with the addition of some derived linguistic features and the removal of others, and subsequent insertion into a database), deriving patterns within the structured data, and finally evaluation and interpretation of the output. It should be noted that “High quality” in text features may refer to some combination of relevance, novelty, and interestingness. Typical text features may include text categorization, text clustering, concept/entity extraction, production of granular taxonomies, sentiment analysis, document summarization, and entity relation modeling (i.e., learning relations between named entities). In some embodiments, text analysis involves information retrieval, lexical analysis to study word frequency distributions, pattern recognition, tagging/annotation, information extraction, data mining techniques including link and association analysis, visualization, and predictive analytics.

At step 1614, the system scores (e.g., via control circuitry 304) the nodes. In some embodiments with many connected components, the system computes these features on each connected component separately. In some embodiments, the system uses the nine (seven text features and two graph features) discussed above, normalizes them, trains a classifier over the manually-curated data and use this model to predict entities. An algorithm that implements classification, especially in a concrete implementation, is known as a classifier. Classification and clustering are examples of the more general problem of pattern recognition, which is the assignment of some sort of output value to a given input value. Other examples are regression, which assigns a real-valued output to each input; sequence labeling, which assigns a class to each member of a sequence of values (for example, part of speech tagging, which assigns a part of speech to each word in an input sentence); parsing, which assigns a parse tree to an input sentence, describing the syntactic structure of the sentence; etc.

In some embodiments, the system trains using a Decision Tree Classifier and Random Forest Classifier. The Decision Tree Classifier is a flow-chart-like structure, where each internal (non-leaf) node denotes a test on an attribute, each branch represents the outcome of a test, and each leaf (or terminal) node holds a class label. The topmost node in a tree is the root node. The Random Forest Classifier may operate by constructing a multitude of decision trees at training time and outputting the class that is the mode of the classes (classification) or mean prediction (regression) of the individual trees. Random decision forests correct for decision trees' habit of overfitting to their training set. It should be noted that the system may implement any decision-tree algorithms. At step 614, the system (e.g., via control circuitry 304) determines the entities (e.g., as shown and described in relation to FIGS. 9-10).

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

What is claimed is:

1. A computer-implemented method, comprising:
receiving a query related to a media content item, wherein the query does not identify a title of the media content item, and wherein the query comprises at least one pronoun;
accessing a database comprising data related to a plurality of media content items;
processing a text string corresponding to the query using pronoun resolution to map the at least one pronoun to at least one term in the text string, to create at least one first link between the at least one pronoun and the at least one term;
applying part-of-speech (POS) tagging on the processed text string to create, for each respective term of the text string, at least one second link with at least one other term in the text string;
identifying nodes to be included in a semantic graph, based at least in part on the at least one first link and the at least one second link, and the data stored at the database;
using a trained machine learning model to:
determine a betweenness centrality metric and a closeness centrality metric with respect to the identified nodes, wherein the closeness centrality metric is a measure of a sum of a length of a shortest path between a respective node and each of the other nodes in the semantic graph, and wherein the betweenness centrality metric is a measure of centrality in the semantic graph of a respective node; and
generate the semantic graph comprising the identified nodes and assigning relevance scores to the identified nodes, based at least in part on the at least one first link, the at least one second link, the betweenness centrality metric, and the closeness centrality metric; and
generating a reply to the query comprising a content recommendation corresponding to the media content item related to the query, based at least in part on the assigned relevance scores of the semantic graph.

2. The method of claim 1, wherein the data stored in the database comprises, for each respective media content item of the plurality of media content items, keywords and descriptions from plot details of the respective media content item.

3. The method of claim 2, wherein identifying nodes to be included in the semantic graph further comprises identifying at least one of the nodes to be included in the semantic graph based on the data stored in the database.

4. The method of claim 2, further comprising:
applying POS tagging to the keywords and descriptions from the plot details of the respective media content item to identify contextual relationships between the keywords and descriptions from the plot details of the respective media content item.

5. The method of claim 2, wherein the contextual relationships between the keywords and descriptions from the plot details of the respective media content item are identified based on manual verification and annotation.

6. The method of claim 2, wherein at least a portion of the data stored at the database is unstructured data, and the generation of the semantic graphs comprises obtaining structured data based at least in part on the unstructured data.

7. The method of claim 1, wherein the pronoun resolution is performed using an end-to-end neural coreference resolution model to resolve references of pronouns in the text string.

8. The method of claim 1, further comprising:
using a dependency tree is used to apply the POS tagging and determine a meaning of the query.

9. The method of claim 1, wherein the trained machine learning model is obtained based at least in part by training a machine learning model using the data stored in the database.

10. The method of claim 1, further comprising:
generating for display the content recommendation at a device at which the query is received.

11. A system, comprising:
control circuitry configured to:
receive a query related to a media content item, wherein the query does not identify a title of the media content item, and wherein the query comprises at least one pronoun;
access a database comprising data related to a plurality of media content items;
process a text string corresponding to the query using pronoun resolution to map the at least one pronoun to at least one term in the text string, to create at least one first link between the at least one pronoun and the at least one term;
apply part-of-speech (POS) tagging on the processed text string to create, for each respective term of the text string, at least one second link with at least one other term in the text string;
identify nodes to be included in a semantic graph, based at least in part on the at least one first link and the at least one second link, and the data stored at the database;
use a trained machine learning model to:
determine a betweenness centrality metric and a closeness centrality metric with respect to the identified nodes, wherein the closeness centrality metric is a measure of a sum of a length of a shortest path between a respective node and each of the other nodes in the semantic graph, and wherein the betweenness centrality metric is a measure of centrality in the semantic graph of a respective node; and
generate the semantic graph comprising the identified nodes and assigning relevance scores to the identified nodes, based at least in part on the at least one first link, the at least one second link, the betweenness centrality metric, and the closeness centrality metric; and
generate a reply to the query comprising a content recommendation corresponding to the media content item related to the query, based at least in part on the assigned relevance scores of the semantic graph.

12. The system of claim 11, wherein the data stored in the database comprises, for each respective media content item of the plurality of media content items, keywords and descriptions from plot details of the respective media content item.

13. The system of claim 12, wherein the control circuitry is further configured to identify nodes to be included in the semantic graph by identifying at least one of the nodes to be included in the semantic graph based on the data stored in the database.

14. The system of claim 12, wherein the control circuitry is further configured to:
applying POS tagging to the keywords and descriptions from the plot details of the respective media content item to identify contextual relationships between the keywords and descriptions from the plot details of the respective media content item.

15. The system of claim 12, wherein the contextual relationships between the keywords and descriptions from the plot details of the respective media content item are identified based on manual verification and annotation.

16. The system of claim 12, wherein at least a portion of the data stored at the database is unstructured data, and the generation of the semantic graphs comprises obtaining structured data based at least in part on the unstructured data.

17. The system of claim 11, wherein the pronoun resolution is performed using an end-to-end neural coreference resolution model to resolve references of pronouns in the text string.

18. The system of claim 11, wherein the control circuitry is further configured to:
use a dependency tree is used to apply the POS tagging and determine a meaning of the query.

19. The system of claim 11, wherein the trained machine learning model is obtained based at least in part by training a machine learning model using the data stored in the database.

20. The system of claim 11, wherein the control circuitry is further configured to:
generate for display the content recommendation at a device at which the query is received.
